(19) United States
(12) Patent Application Publication
(10) Pub. No.: US 2026/0291192 A1
(43) Pub. Date: Sep. 24, 2026

(54) CABLE MANAGER AND WATERPROOF HOUSING ASSEMBLY HAVING THE SAME

(71) Applicant: Getac Technology Corporation, New Taipei City (TW)

(72) Inventor: Kun-Cheng LEE, Taipei City (TW)

(21) Appl. No.: 19/320,083

(22) Filed: Sep. 5, 2025

(30) Foreign Application Priority Data
Mar. 19, 2025 (TW) 114110290

(51) Int. Cl. H02G 3/04; H02G 3/08

(52) U.S. Cl. CPC H02G 3/0437; H02G 3/088

(57) ABSTRACT

A cable manager includes a body, a first cable buckle portion, a second cable buckle portion, a channel, and two engaging slots. The body has a first side and a second side opposite to each other, and a third side and a fourth side opposite to each other. The first cable buckle portion is disposed on the first side. The second cable buckle portion is disposed on the second side. The channel is connected with the first side and the second side. The two engaging slots are respectively disposed on the third side and the fourth side.

### CROSS-REFERENCE TO RELATED APPLICATION

This application claims priority to Taiwan Application Serial Number 114110290, filed Mar 19, 2025, which is herein incorporated by reference in its entirety.

### BACKGROUND

### Field of Disclosure

The present disclosure relates to a cable manager and a waterproof housing assembly having the same.

### Description of Related Art

In recent times, the utilization of space inside the housing of electronic devices is increasing as the performance of electronic devices continues to improve. It is becoming more important to improve the efficiency of space utilization without increasing the size of the electronic devices. In particular, the cables in electronic devices often need to be stored in cable managers and waterproof housing assemblies to avoid clutter in the internal space of the electronic device housing. Taking a conventional cable manager and waterproof housing assembly as an example, the cable manager and waterproof housing assembly mainly achieve the requirements of storing various cables and waterproofing through the cable threading design on both sides of the electronic device housing.

However, although the conventional cable manager and waterproof housing assembly can store different types of cables on both sides of the electronic device housing and can be waterproof, they still cannot overcome the above-mentioned problem and effectively utilize the internal space of the electronic device housing.

Accordingly, providing a cable manager and a waterproof housing assembly to solve the aforementioned problems has become an important issue to be solved by those in the industry.

### SUMMARY

An aspect of the disclosure is to provide a cable manager and a waterproof housing assembly that can efficiently solve the aforementioned problems.

According to an embodiment of the disclosure, a cable manager includes a body, a first cable buckle portion, a second cable buckle portion, a channel, and two engaging slots. The body has a first side and a second side opposite to each other, and a third side and a fourth side opposite to each other. The first cable buckle portion is disposed on the first side. The second cable buckle portion is disposed on the second side. The channel is connected with the first side and the second side. The two engaging slots are respectively disposed on the third side and the fourth side.

In an embodiment of the disclosure, two ends of each of the two engaging slots extend to the first side and the second side of the body respectively.

In an embodiment of the disclosure, the channel has a first recessing slot and a second recessing slot. The first recessing slot is located on the first side and is connected with the first cable buckle portion. The second recessing slot is located on the second side and is connected with the second cable buckle portion. The first recessing slot is connected with the second recessing slot via at least one connecting portion.

In an embodiment of the disclosure, the cable manager further comprises at least one partitioning portion. The at least one partitioning portion is disposed in the channel to form the at least one connecting portion. The at least one connecting portion is connected with the first recessing slot and the second recessing slot in the channel.

In an embodiment of the disclosure, the cable manager further comprises a colloid. The colloid is configured to seamlessly fill the first recessing slot and the second recessing slot through the at least one connecting portion.

In an embodiment of the disclosure, the body further has a fifth side and a sixth side opposite to each other. The third side, the fifth side, the fourth side and the sixth side are sequentially arranged around outer edges of the first side and the second side. The first cable buckle portion includes at least one first cable buckle groove. The at least one first cable buckle groove is connected with the fifth side and the sixth side via the channel. The second cable buckle portion includes at least one second cable buckle groove. The at least one second cable buckle groove is connected with the fifth side and the sixth side via the channel.

In an embodiment of the disclosure, a waterproof housing assembly includes a cable manager, a bottom plate, and two connecting walls. The cable manager includes a body, a first cable buckle portion, a second cable buckle portion, a channel, and two engaging slots. The body has a first side and a second side opposite to each other, and a third side and a fourth side opposite to each other. The first cable buckle portion is disposed on the first side, and includes at least one first cable buckle groove. The second cable buckle portion is disposed on the second side, and includes at least one second cable buckle groove. The channel is connected with the first side and the second side. The two engaging slots are respectively disposed on the third side and the fourth side. The two connecting walls are disposed on the bottom plate. A cavity is formed between the two connecting walls. The body of the cable manager is located in the cavity. The second side abuts against the bottom plate. The two connecting walls are respectively engaged with the two engaging slots.

In an embodiment of the disclosure, the waterproof housing assembly further comprises a cover. The cover is disposed on the first side of the body. The two connecting walls respectively abut against two opposite sides of the cover.

In an embodiment of the disclosure, the cover comprises a convex rib. The convex rib is located on a side of the cover away from the body. The convex rib is abutted between the two connecting walls.

In an embodiment of the disclosure, a height of an upper edge of the convex rib relative to the bottom plate is equal to a height of upper edges of the two connecting walls relative to the bottom plate.

In an embodiment of the disclosure, the waterproof housing assembly further comprises two spaced walls. The two spaced walls are disposed on the bottom plate and are respectively connected to opposite sides of the two connecting walls. The body is abutted between the two spaced walls.

In an embodiment of the disclosure, the body further has a fifth side and a sixth side opposite to each other. The third side, the fifth side, the fourth side and the sixth side are seamlessly abutted between the two spaced walls and the two connecting walls.

In an embodiment of the disclosure, a spacing is formed between the cover and the two spaced walls. The spacing is connected with the channel via the first cable buckle portion and the second cable buckle portion.

In an embodiment of the disclosure, the two spaced walls comprise an opening. The opening has a size corresponding to the first cable buckle groove and the second cable buckle groove.

In an embodiment of the disclosure, the waterproof housing assembly further comprises a colloid. The colloid fills the channel to seal a gap between the cover and the bottom plate.

Accordingly, in the cable manager of the present disclosure, the first cable buckle portion and the second cable buckle portion are respectively arranged on opposite sides of the body of the cable manager, so that the cable manager can be divided into an upper and lower storage structure, and the internal space of the waterproof housing assembly is fully utilized to store cables. The channel in the body provides a path for the waterproof colloid to flow, so that the waterproof colloid can completely and tightly cover upper and lower layers of cables to achieve a waterproof effect. Through the engaging slot of the body, the cable manager can be engaged with the wall of the waterproof housing assembly to prevent displacement and shaking.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a cable manager according to an embodiment of the present disclosure;

FIG. 2 is a partial cross-sectional view of the cable manager in FIG. 1 along the section line 2A-2A;

FIG. 3A is a partial perspective view of a waterproof housing assembly according to an embodiment of the present disclosure;

FIG. 3B is a partial perspective view showing the waterproof housing assembly in FIG. 3A after being assembled with the cable manager in FIG. 1; and

FIG. 4 is a partial perspective side view showing the waterproof housing assembly in FIG. 3B after being assembled with a cover.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

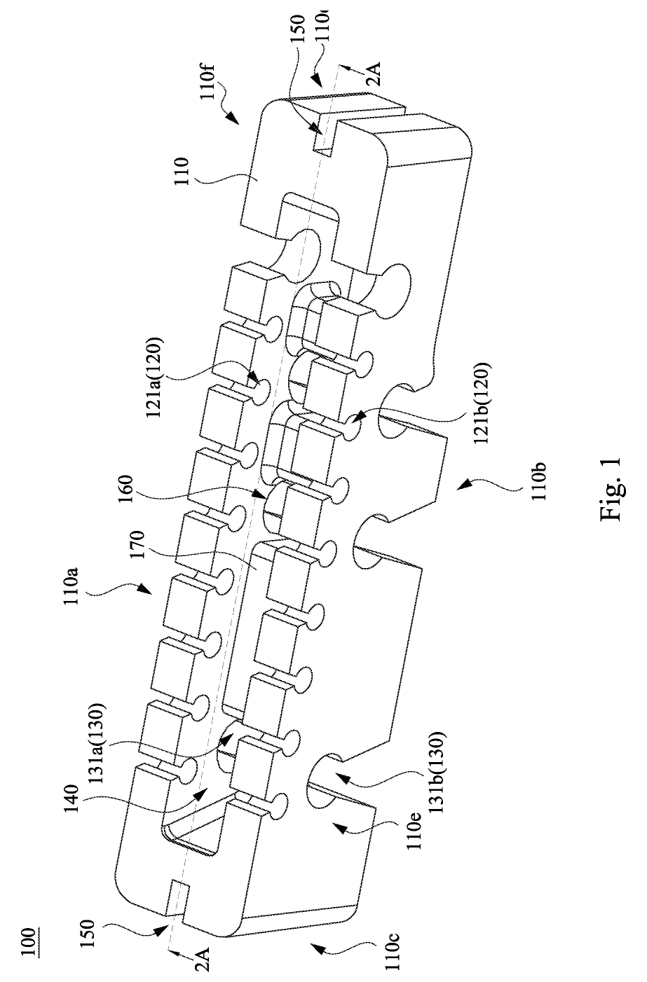

Reference is made to FIG. 1. FIG. 1 is a perspective view of a cable manager 100 according to an embodiment of the present disclosure. As shown in FIG. 1, in the present embodiment, the cable manager 100 includes a body 110, a first cable buckle portion 120, a second cable buckle portion 130, a channel 140, and two engaging slots 150. The body 110 has a first side 110a and a second side 110b opposite to each other, and a third side 110c and a fourth side 110d opposite to each other and each connecting the first side 110a and the second side 110b. The first cable buckle portion 120 is disposed on the first side 110a of the body 110, and the second cable buckle portion 130 is disposed on the second side 110b of the body 110. The first cable buckle portion 120 and the second cable buckle portion 130 can divide the body 110 into an upper and lower storage structure, so that cables can be stored in a limited space by making full use of the first cable buckle portion 120 and the second cable buckle portion 130 on upper and lower layers, thereby minimizing use of the internal space of an electronic device. The channel 140 is connected with the first side 110a and the second side 110b and forms a hollow interconnected channel in the body 110. The two engaging slots 150 are respectively disposed on the third side 110c and the fourth side 110d of the body 110, and two ends of each of the two engaging slots 150 can respectively extend to the first side 110a and the second side 110b of the body 110, so that the body 110 can be firmly engaged in any electronic device requiring power distribution, but the disclosure is not limited in this regard. In other embodiments, the two ends of each of the two engaging slots 150 may not extend to the first side 110a and the second side 110b respectively, and the body 110 may also be used to accommodate various types of wires or cables other than conductive cables.

As shown in FIG. 1, in this embodiment, the body 110 further includes a fifth side 110e and a sixth side 110f opposite to each other. The third side 110c, the fifth side 110e, the fourth side 110d and the sixth side 110f of the body 110 are sequentially arranged around the outer edges of the first side 110a and the second side 110b and connect the first side 110a and the second side 110b of the body 110. The first cable buckle portion 120 includes at least one first cable buckle groove 121a, 121b, and the second cable buckle portion 130 includes at least one second cable buckle groove 131a, 131b. The first cable buckle groove 121a, 121b and the second cable buckle groove 131a, 131b are connected with either the fifth side 110e or the sixth side 110f of the body 110 and to the channel 140. In other words, one side of the first and second cable buckle grooves 121a and 131a is located on the sixth side 110f of the body 110, and the other side of the first and second cable buckle grooves 121a and 131a opposite to said one side is located at the channel 140. In addition, one side of the first and second cable buckle grooves 121b and 131b is located on the fifth side 110e of the body 110, and the other side of the first and second cable buckle grooves 121b and 131b opposite to said one side is located at the channel 140.

As shown in FIG. 1, in this embodiment, a cable (not shown) may be disposed on the first cable buckle portion 120 of the first side 110a of the body 110 or the second cable buckle portion 130 of the second side 110b of the body 110. The cable can enter the channel 140 from the sixth side 110f of the body 110 through the first cable buckle groove 121a or the second cable buckle groove 131a and pass through the fifth side 110e of the body 110 in a direction parallel to the first cable buckle groove 121b or the second cable buckle groove 131b. Similarly, the cable can also enter the channel 140 from the fifth side 110e of the body 110 through the first cable buckle groove 121b or the second cable buckle groove 131b and pass through the sixth side 110f of the body 110 in a direction parallel to the first cable buckle groove 121a or the second cable buckle groove 131a, but the disclosure is not limited in this regard. In some embodiments, when the cable enters the channel 140 through the first cable buckle groove 121a or the second cable buckle groove 131a, the cable may also be threaded toward the first cable buckle groove 121b or the second cable buckle groove 131b which is not parallel to the first cable buckle groove 121a or the second cable buckle groove 131b. Similarly, when the cable enters the channel 140 through the first cable buckle groove 121b or the second cable buckle groove 131b, the cable can also be threaded toward the first cable buckle groove 121a or the second cable buckle groove 131a which is not parallel to the first cable buckle groove 121b or the second cable buckle groove 131b.

As shown in FIG. 1, in this embodiment, the first cable buckle grooves 121a, 121b and the second cable buckle grooves 131a, 131b can be used to store cables (not shown), and their number and size are not fixed and can be adjusted according to the number and size of the cables. In this embodiment, the first cable buckle grooves 121a and 121b can accommodate thinner cables, and the second cable buckle grooves 131a and 131b can accommodate thicker cables. The number of the first cable buckle grooves 121a and 121b can be greater than the number of the second cable buckle grooves 131a and 131b, but the disclosure is not limited in this regard. In other embodiments, the first cable buckle grooves 121a, 121b can also accommodate thicker cables, and the second cable buckle grooves 131a, 131b can also accommodate thinner cables, or the first cable buckle grooves 121a, 121b and the second cable buckle grooves 131a, 131b can accommodate cables of the same size, or the first cable buckle grooves 121a, 121b and the second cable buckle grooves 131a, 131b can respectively and simultaneously accommodate cables of different sizes. In addition, the number of the second cable buckle grooves 131a and 131b may be greater than the number of the first cable buckle grooves 121a and 121b, and the number of the first cable buckle grooves 121a and 121b and the number of the second cable buckle grooves 131a and 131b may be the same.

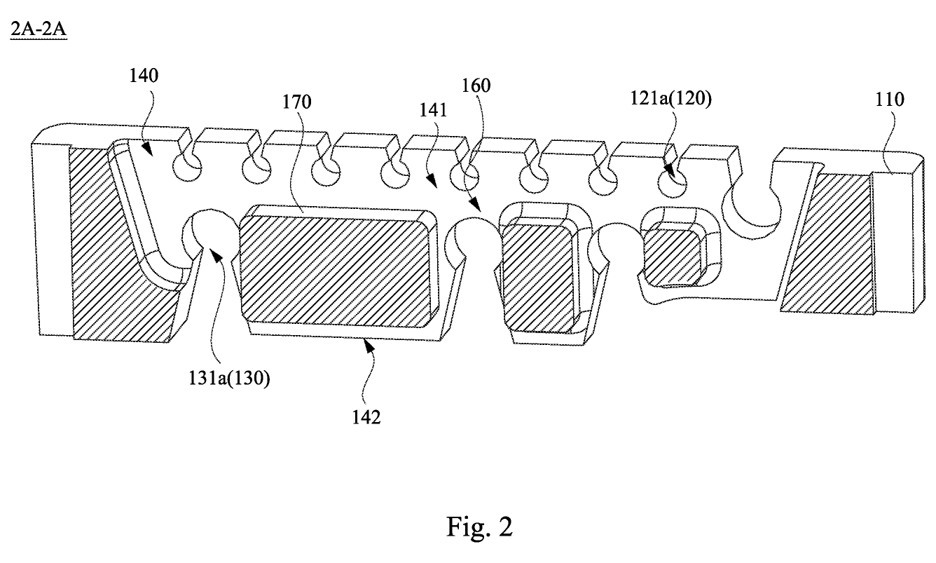

Reference is made to FIG. 2. FIG. 2 is a partial cross-sectional view of the cable manager 100 in FIG. 1 along the section line 2A-2A. As shown in FIG. 1 and FIG. 2, in this embodiment, the channel 140 has a first recessing slot 141 located at the first side 110a of the body 110, and a second recessing slot 142 located at the second side 110b of the body 110. The first recessing slot 141 is connected with the first cable buckle portion 120, the second recessing slot 142 is connected with the second cable buckle portion 130, and the first recessing slot 141 and the second recessing slot 142 are connected with each other via a connecting portion 160. The connecting portion 160 can serve as a channel for a waterproof colloid (not shown) to flow, ensuring that the waterproof colloid completely fills the first recessing slot 141 and the second recessing slot 142 to completely cover the cables in the first cable buckle grooves 121a, 121b and the second cable buckle grooves 131a, 131b to prevent the cables from shifting or being soaked in water, thereby achieving the purpose and effect of waterproofing.

As shown in FIG. 1 and FIG. 2, the cable manager 100 includes a partition portion 170 disposed in the channel 140. The partition portion 170 connects the fifth side 110e and the sixth side 110f of the body 110, which are opposite to each other, to separate the first recessing slot 141 and the second recessing slot 142 of the channel 140, and form the connecting portion 160. In other words, the connecting portion 160 is a portion formed by separating one or more connecting channels in the channel 140 through the partition portion 170.

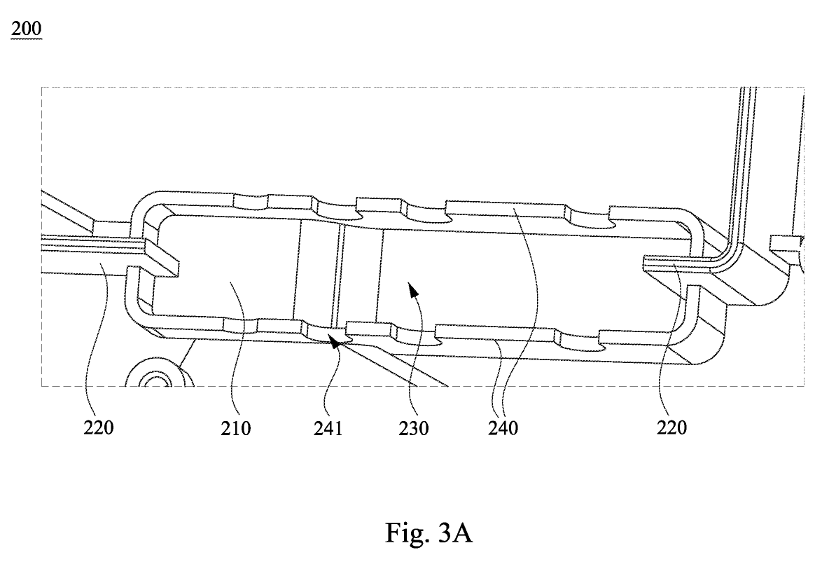

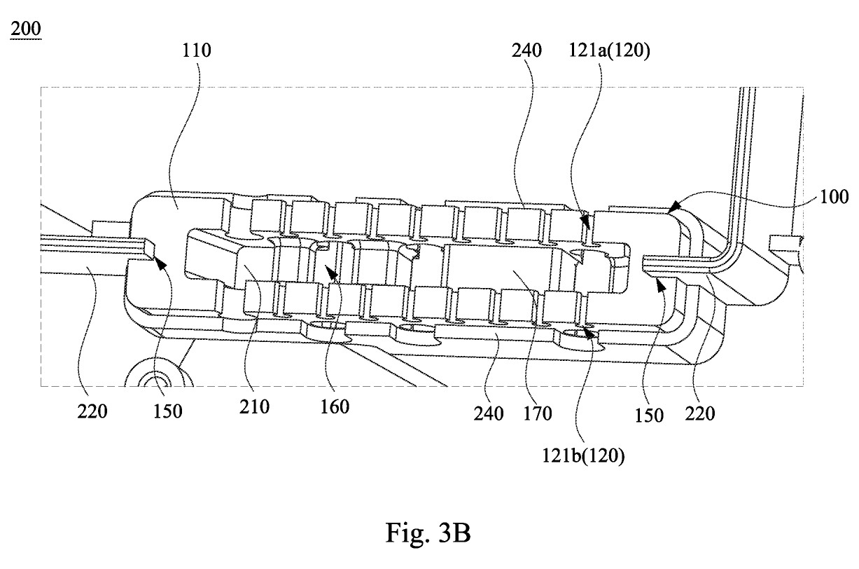

Reference is made to FIG. 3A and FIG. 3B. FIG. 3A is a partial perspective view of a waterproof housing assembly 200 according to an embodiment of the present disclosure. FIG. 3B is a partial perspective view showing the waterproof housing assembly 200 in FIG. 3A after being assembled with the cable manager 100 in FIG. 1. As shown in FIG. 3A and FIG. 3B, in this embodiment, the waterproof housing assembly 200 includes the cable manager 100, a bottom plate 210, two connecting walls 220, and two spaced walls 240. The two connecting walls 220 are disposed on opposite sides of the bottom plate 210, and the two spaced walls 240 are also disposed on the bottom plate 210. The two spaced walls 240 connect opposite sides of the two connecting walls 220, respectively. A cavity 230 is formed between the two connecting walls 220, the two spaced walls 240 and the bottom plate 210, and the body 110 of the cable manager 100 is located in the cavity 230. The second side 110b of the body 110 abuts against the bottom plate 210, and the third side 110c, the fifth side 110e, the fourth side 110d and the sixth side 110f of the body 110 are seamlessly abutted between the two spaced walls 240 and the two connecting walls 220. In other words, the size of the cavity 230 is almost identical to that of the cable manager 100. By completely and seamlessly fitting with the spaced walls 240, the overall tightness and waterproofing effect of the waterproof housing assembly 200 are increased to thereby prevent moisture from entering the cable manager 100. In this embodiment, the two connecting walls 220 are respectively disposed on the third side 110c and the fourth side 110d of the body 110, and are respectively engaged with the two engaging slots 150, so as to better fix the cable manager 100 in the waterproof housing assembly 200.

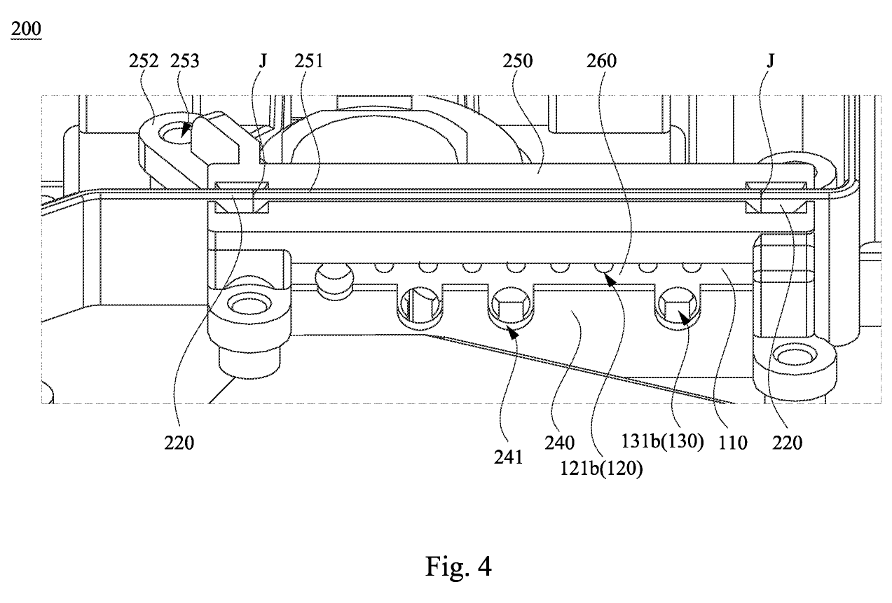

Reference is made to FIG. 4. FIG. 4 is a partial perspective side view showing the waterproof housing assembly 200 in FIG. 3B after being assembled with a cover 250. As shown in FIG. 1 and FIG. 4, in this embodiment, the waterproof housing assembly 200 further includes the cover 250 disposed on the first side 110a of the body 110, and the two connecting walls 220 respectively abut against two opposite sides of the cover 250. The waterproof housing assembly 200 can be a housing of any electronic device, and the cover 250 can be locked to the waterproof housing assembly 200, thereby fixing the cable manager 100 and cables (not shown) to achieve the purpose of waterproofing. In some embodiments, the cover 250 may have a support leg 252 (see FIG. 4), and the support leg 252 has a locking hole 253 for locking the cover 250 on the waterproof housing assembly 200. In this embodiment, the cover 250 includes a convex rib 251. The convex rib 251 is located at a side of the cover 250 away from the body 110 and is seamlessly abutted between the two connecting walls 220 at connection lines J. Specifically, the convex rib 251 and the upper edges of the two connecting walls 220 are substantially at the same height relative to the bottom plate 210 of the waterproof housing assembly 200. The waterproof housing assembly 200 of the electronic device may further include a top plate (not shown) and a waterproof gasket (such as a sponge gasket) disposed on the top plate. Therefore, when the top plate is assembled to the bottom plate 210, the waterproof gasket can be pressed against the convex rib 251 and the upper edge of the connecting walls 220 at the same time to prevent liquid from flowing between the two opposite sides of the connecting walls 220.

With reference to FIG. 1 and FIG. 4, in this embodiment, a spacing 260 is formed between the cover 250 and the two spaced walls 240, and the spacing 260 is connected with the channel 140 via the first cable buckle portion 120 and the second cable buckle portion 130. In other words, although the cover 250 covers the cable manager 100 and the waterproof housing assembly 200, there is a partially exposed gap (i.e., the spacing 260) between the cover 250 and the spaced walls 240. As shown in FIG. 4, the first and second cable buckle portions 120 and 130 are visible from the spacing 260, and the spaced wall 240 has a cable outlet opening 241 of a size corresponding to the first and second cable buckle grooves 121b and 131b at the cable outlets of the first and second cable buckle grooves 121b and 131b. It should be noted that the spaced walls 240 also have a cable outlet opening 241 with a size corresponding to the first cable buckle groove 121a and the second cable buckle groove 131a at the cable outlet of the first cable buckle groove 121a and the second cable buckle groove 131a, but the disclosure is not limited in this regard. In some embodiments, the cable outlet opening 241 of the spaced walls 240 may not completely correspond to the cable outlet size of the first cable buckle groove 121a, 121b or the second cable buckle groove 131a, 131b. It is necessary only that the cable outlet opening 241 of the spaced walls 240 allows the cable (not shown) to pass through the spacing 260. Specifically, the function of the spacing 260 is to provide a space for the cables to be threaded and exited, so that the cables can pass through the channel 140 from the fifth side 110e or the sixth side 110f of the body 110 and extend outward in a direction away from the waterproof housing assembly 200.

As shown in FIG. 1 and FIG. 4, in this embodiment, the waterproof housing assembly 200 may further include a colloid (not shown), which may seamlessly fill the channel 140 to seal the gap between the cover 250 and the bottom plate 210. In one embodiment of the present disclosure, when operating or using the cable manager 100, the cables can be first threaded and buckled into the second cable buckle grooves 131a and 131b, and the cable manager 100 is placed into the cavity 230 of the waterproof housing assembly 200, so that the cables can extend outward through the spacing 260. Next, other cables can be threaded and buckled to the first cable buckle grooves 121a and 121b in sequence, so that the cables can extend outward through the spacing 260 in the same manner. When all the cables are stored and buckled in the cable manager 100, the waterproof colloid can be injected into the channel 140 so that the gap between the cover 250 and the bottom plate 210 is completely filled with the waterproof colloid to form a seamless sealed space, and the cover 250 is covered to fix the cable manager 100 and the cables to achieve a waterproof effect, but the disclosure is not limited in this regard. In some embodiments, the cables may be threaded and buckled to the first cable buckle grooves 121a, 121b and the second cable buckle grooves 131a, 131b before the cable manager 100 is placed into the cavity 230. The waterproof colloid may also be injected into the channel 140 after the cover 250 is closed.

In this embodiment, the cable manager 100 may be a waterproof structure made of rubber, but the disclosure is not limited in this regard. The cable manager 100 may also be made of other materials with a waterproof function.

According to the foregoing recitations of the embodiments of the disclosure, it can be seen that in the cable manager of the present disclosure, the first cable buckle portion and the second cable buckle portion are respectively arranged on opposite sides of the body of the cable manager, so that the cable manager can be divided into an upper and lower storage structure, and the internal space of the waterproof housing assembly is fully utilized to store cables. The channel in the body provides a path for the waterproof colloid to flow, so that the waterproof colloid can completely and tightly cover upper and lower layers of cables to achieve a waterproof effect. Through the engaging slot of the body, the cable manager can be engaged with the wall of the waterproof housing assembly to prevent displacement and shaking.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cable manager, comprising:
a body having a first side and a second side opposite to each other, and a third side and a fourth side opposite to each other;
a first cable buckle portion disposed on the first side;
a second cable buckle portion disposed on the second side;
a channel connected with the first side and the second side; and
two engaging slots respectively disposed on the third side and the fourth side.

2. The cable manager of claim 1, wherein two ends of each of the two engaging slots extend to the first side and the second side of the body respectively.

3. The cable manager of claim 1, wherein the channel has a first recessing slot and a second recessing slot, the first recessing slot is located on the first side and connected with the first cable buckle portion, the second recessing slot is located on the second side and connected with the second cable buckle portion, and the first recessing slot is connected with the second recessing slot via at least one connecting portion.

4. The cable manager of claim 3, further comprising at least one partitioning portion, wherein the at least one partitioning portion is disposed in the channel to form the at least one connecting portion connected with the first recessing slot and the second recessing slot in the channel.

5. The cable manager of claim 3, further comprising a colloid, the colloid being configured to seamlessly fill the first recessing slot and the second recessing slot through the at least one connecting portion.

6. The cable manager of claim 1, wherein the body further has a fifth side and a sixth side opposite to each other, the third side, the fifth side, the fourth side and the sixth side are sequentially arranged around outer edges of the first side and the second side, the first cable buckle portion comprises at least one first cable buckle groove, the at least one first cable buckle groove is connected with the fifth side and the sixth side via the channel, the second cable buckle portion comprises at least one second cable buckle groove, and the at least one second cable buckle groove is connected with the fifth side and the sixth side via the channel.

7. A waterproof housing assembly, comprising:
a cable manager comprising:
a body having a first side and a second side opposite to each other, and a third side and a fourth side opposite to each other;
a first cable buckle portion disposed on the first side, comprising at least one first cable buckle groove;
a second cable buckle portion disposed on the second side, comprising at least one second cable buckle groove;
a channel connected with the first side and the second side; and
two engaging slots respectively disposed on the third side and the fourth side;
a bottom plate; and
two connecting walls disposed on the bottom plate, a cavity being formed between the two connecting walls, wherein the body of the cable manager is located in the cavity, the second side abuts against the bottom plate, and the two connecting walls are respectively engaged with the two engaging slots.

8. The waterproof housing assembly of claim 7, further comprising a cover disposed on the first side of the body, wherein the two connecting walls respectively abut against two opposite sides of the cover.

9. The waterproof housing assembly of claim 8, wherein the cover comprises a convex rib located on a side of the cover away from the body, and the convex rib is abutted between the two connecting walls.

10. The waterproof housing assembly of claim 9, wherein a height of an upper edge of the convex rib relative to the bottom plate is equal to a height of upper edges of the two connecting walls relative to the bottom plate.

11. The waterproof housing assembly of claim 9, further comprising two spaced walls, wherein the two spaced walls are disposed on the bottom plate and are respectively connected to opposite sides of the two connecting walls, and the body is abutted between the two spaced walls.

12. The waterproof housing assembly of claim 11, wherein the body further has a fifth side and a sixth side opposite to each other, the third side, the fifth side, the fourth side and the sixth side are seamlessly abutted between the two spaced walls and the two connecting walls.

13. The waterproof housing assembly of claim 11, wherein a spacing is formed between the cover and the two spaced walls, and the spacing is connected with the channel via the first cable buckle portion and the second cable buckle portion.

14. The waterproof housing assembly of claim 11, wherein the two spaced walls comprise an opening, and the opening has a size corresponding to the at least one first cable buckle groove and the at least one second cable buckle groove.

15. The waterproof housing assembly of claim 8, further comprising a colloid filling the channel to seal a gap between the cover and the bottom plate.
